(19) United States
(12) Patent Application Publication
(10) Pub. No.: US 2013/0078399 A1
(43) Pub. Date: Mar. 28, 2013

(54) METHOD FOR MAKING HOUSING AND HOUSING MADE BY SAME

(71) Applicants: CHAO-YI YU, Shenzhen City (CN); XU LIU, Shenzhen City (CN); TING DING, Shenzhen City (CN)

(72) Inventors: CHAO-YI YU, Shenzhen City (CN); XU LIU, Shenzhen City (CN); TING DING, Shenzhen City (CN)

(73) Assignees: FIH (HONG KONG) LIMITED, Kowloon (HK); SHENZHEN FUTAIHONG PRECISION INDUSTRY CO., LTD., ShenZhen City (CN)

(21) Appl. No.: 13/481,007

(22) Filed: May 25, 2012

(30) Foreign Application Priority Data
Sep. 26, 2011 (CN) 201110288436.1

(51) Int. Cl. C25D 11/04; B32B 1/00; B32B 5/18; C25D 11/16; B32B 15/20; B82Y 40/00; B82Y 30/00

(52) U.S. Cl. 428/34.1; 205/202; 977/781

(57) ABSTRACT

A method for making a housing of an electronic device comprises the following steps: providing an aluminum or aluminum alloy substrate; anodizing the aluminum or aluminum alloy substrate to form an anodic oxide layer; screen printing ink on a portion of the surface of the anodic oxide layer and then drying the ink to form an ink layer; dying the anodic oxide layer to form a colorant layer on the surface of the anodic oxide layer not covered by the ink layer; and sealing the anodic oxide layer.

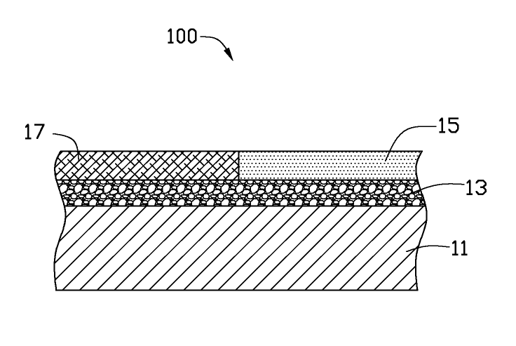

### BACKGROUND

1. Technical Field

The present disclosure relates to housings and a method for making the housings.

2. Description of Related Art

Anodic oxidation treatments can be applied to decorate housings of electronic devices with color. However, by subjecting one anodic oxidation treatment, the housing may be monochromatic. To get multicolored appearance for the housing, different anodic oxidation processes may be repeatedly applied to the housing, as well as the multiple masking processes and partially removing processes of preformed anodic layers. Thus, the process for obtaining a multicolored appearance of the housing is complex.

Therefore, there is room for improvement within the art.

### BRIEF DESCRIPTION OF THE FIGURE

Many aspects of the housing can be better understood with reference to the following drawing. The components in the drawing are not necessarily drawn to scale, the emphasis instead being placed upon clearly illustrating the principles of the housing. Moreover, in the drawing like reference numerals designate corresponding parts throughout the drawing.

The figure is a cross-sectional view of an exemplary embodiment of a housing.

### DETAILED DESCRIPTION

The figure shows a housing 100 according to an exemplary embodiment. A method for making the housing 100 may include the following steps.

A substrate 11 made of aluminum or aluminum alloy is provided.

The substrate 11 is pretreated. The pretreatment includes the following steps in order: degreasing the substrate 11, rinsing the substrate 11, acid etching the substrate 11, chemically polishing the substrate 11, rinsing the substrate 11, desmuting the substrate 11, and rinsing the substrate 11.

The degreasing process is carried out in a degreaser water solution having a concentration of about 10 ml/L at a temperature of about 60° C.

The acid etching process is carried out by dipping the substrate 11 in a phosphorous acid water solution having a mass percentage of about 85% for about 10 seconds.

The chemical polishing process uses a polishing water solution containing phosphorous acid having a concentration of about 700 ml/L to about 800 ml/L, and sulphuric acid having a concentration of about 200 ml/L to about 300 ml/L at a temperature of about 84° C. to about 88° C.

The desmuting process is carried out by dipping the substrate 11 in a nitric acid water solution having a mass percentage of about 30% to about 40% at room temperature for about 5 min.

The aluminum or aluminum alloy substrate 11 is anodized to form a porous anodic oxide layer 13 on the substrate 11 using an electrolyte. The electrolyte contains sulphuric acid having a concentration of about 180 g/L to about 200 g/L, and aluminum ions having a concentration of less than 20 g/L. The electrolyte has a temperature of about 15° C. to about 20° C. During the anodizing process, the substrate 11 is applied with a voltage of about 11 V to about 13 V. The anodizing process may last for about 30 min to about 50 min. The anodic oxide layer 13 has a thickness of about 10 μm to about 15 μm. The anodic oxide layer 13 defines a plurality of nanopores having an average diameter in a range of about 10 nm to about 100 nm.

The anodized substrate 11 is rinsed in water and then dried at a temperature of 60° C. to about 70° C. for about 30 min.

A portion of surface of the anodic oxide layer 13 is screen printed with ink and then dried at a temperature of about 60° C. to 70° C. for about 1 hour to form an ink layer 15. A portion of ink of the ink layer 15 transit to and fill the nanopores of the anodic oxide layer 13. The ink layer 15 may present a designed pattern.

The substrate 11 having the ink layer 15 is ultrasonic cleaned in water and then dried.

The substrate 11 having the ink layer 15 is dyed with colorant to form a colorant layer 17 on the surface of the anodic oxide layer 13 not covered by the ink layer 15. The colorant cannot penetrate through the ink layer 15.

The dyed substrate 11 is sealed, followed by a rinsing and a drying process. As such, the housing 100 is obtained.

Before the dying process, the housing 100 may be screen printed repeatedly to form multiple different colors of ink layers.

The housing 100 made by the above method includes an aluminum or aluminum alloy substrate 11 and an anodic oxide layer 13 formed on the substrate 11. The anodic oxide layer 13 defines a plurality of nanopores. The nanopores have an average diameter in a range of about 10 nm to about 100 nm. An ink layer 15 is formed on a portion of the surface of the anodic oxide layer 13, and a colorant layer 17 is formed on the other portion surface of the anodic oxide layer 13 not covered by the ink layer 15. The nanopores of the anodic oxide layer 13 covered by the ink layer 15 are filled with the ink of the ink layer 15, and the nanopores of the anodic oxide layer 13 covered by the colorant layer 17 are filled with colorant of the colorant layer 17.

### EXAMPLE

Experimental example of the present disclosure is described as followings.

An aluminum alloy substrate 11 was provided and pretreated.

The aluminum alloy substrate 11 was anodized to form an anodic oxide layer 13. The electrolyte contained sulphuric acid having a concentration of about 190 g/L, and aluminum ions having a concentration of less than 20 g/L. The electrolyte had a temperature of about 19° C. The voltage applied to the aluminum alloy substrate 11 was about 12 V. The anodizing process lasted for about 30 min.

The anodized aluminum alloy substrate 11 was rinsed in water and then dried at a temperature of 60° C. for about 30 min.

A portion of surface of the anodic oxide layer 13 was screen printed with ink from Clariant Chemical Group Co., Ltd. (product model: aluprint 3R) and then dried at a temperature of about 60° C. to 70° C. for about 1 hour to form the ink layer 15.

The aluminum alloy substrate 11 having the ink layer 15 was dyed using the colorant from Clariant Chemical Group Co., Ltd. (product model: F001) at room temperature for about 5 seconds to about 8 seconds. The colorant had a concentration of about 7.5 g/L.

The aluminum alloy substrate 11 was sealed using a sealant from Eternal Chemical Co., Ltd. (product model: R500) at a temperature of about 80° C. for about 30 min. The R500 sealant had a concentration of about 20 g/L to about 30 g/L.

Corrosion resistance test and adhesion test were applied to the housing 100 of the example.

The corrosion resistance test was carried out using a salt spray tester (model No.: TMJ9701) and a constant temperature and humidity tester. The salt spray tester contained sodium chloride water solution having a mass concentration of about 5% and a temperature of about 35° C. The housing 100 was first positioned in the salt spray tester for 2 hours, and then positioned in the constant temperature and humidity tester having a temperature of about 40° C. and a humidity of about 93% for 168 hours. The test result showed that the housing 100 was not corroded.

An adhesion test was also applied to the housing 100 using a cross-cut test. The test indicated that the ink layer 15 and the colorant layer 17 didn't peel off from the anodic oxide layer 13.

The housing 100 may be a shell of electronic device, such as a mobile phone.

It is believed that the exemplary embodiment and its advantages will be understood from the foregoing description, and it will be apparent that various changes may be made thereto without departing from the spirit and scope of the disclosure or sacrificing all of its advantages, the examples hereinbefore described merely being preferred or exemplary embodiment of the disclosure.

What is claimed is:

1. A method for making a housing of an electronic device, comprising:
providing an aluminum or aluminum alloy substrate;
anodizing the aluminum or aluminum alloy substrate to form an anodic oxide layer;
screen printing ink on a portion of the surface of the anodic oxide layer and then drying the ink to form an ink layer;
dying the anodic oxide layer to form a colorant layer on the surface of the anodic oxide layer not covered by the ink layer; and
sealing the anodic oxide layer.

2. The method as claimed in claim 1, wherein anodizing the aluminum or aluminum alloy substrate uses an electrolyte containing sulphuric acid having a concentration of about 180 g/L to about 200 g/L, and aluminum ions having a concentration of less than 20 g/L, the electrolyte has a temperature of about 15° C. to about 20° C., the aluminum or aluminum alloy substrate is applied with a voltage of about 11 V to about 13 V for about 30 min to about 50 min.

3. The method as claimed in claim 1, wherein drying the ink is carried out at a temperature of about 60° C. to about 70° C. for about 60 min.

4. The method as claimed in claim 1, wherein a plurality of nanopores is formed in the anodic oxide layer, the nanopores are filled with the ink and the colorant.

5. The method as claimed in claim 4, wherein the nanopores have an average diameter in a range of about 10 nm to about 100 nm.

6. The method as claimed in claim 1, wherein further comprising a step of pretreating the aluminum or aluminum alloy substrate prior to anodizing the aluminum or aluminum alloy substrate.

7. The method as claimed in claim 6, wherein the pretreatment of the aluminum or aluminum alloy substrate comprises includes the steps in order: degreasing, rinsing, acid etching, chemically polishing, rinsing, desmuting, and rinsing.

8. A housing of an electronic device, comprising:
an aluminum or aluminum alloy substrate; and
an anodic oxide layer formed on a surface of the aluminum or aluminum alloy substrate;
wherein the anodic oxide layer defines a plurality of nanopores having an average diameter in a range of about 10 nm to about 100 nm, an ink layer and a colorant layer are formed on different region of the surface of the anodic oxide layer.

9. The housing as claimed in claim 1, wherein the nanopores of the anodic oxide layer covered by the ink layer are filled with the ink of the ink layer.

10. The housing as claimed in claim 1, wherein the nanopores of the anodic oxide layer covered by the colorant layer are filled with colorant of the colorant layer.
